(19) United States
(12) Patent Application Publication
(10) Pub. No.: US 2025/0284104 A1
(43) Pub. Date: Sep. 11, 2025

(54) ZOOM PROJECTION LENS AND ELECTRONIC DEVICE

(71) Applicant: GOERTEK OPTICAL TECHNOLOGY CO., LTD., Shandong (CN)

(72) Inventor: YUN ZHAO, Shandong (CN)

(73) Assignee: GOERTEK OPTICAL TECHNOLOGY CO., LTD., Shandong (CN)

(21) Appl. No.: 18/861,259

(22) PCT Filed: Jun. 28, 2022
(86) PCT No.: PCT/CN2022/102034

§ 371 Date: Oct. 29, 2024

(30) Foreign Application Priority Data
Apr. 29, 2022 (CN) 202210475065.6

(51) Int. Cl. G02B 15/14; G02B 13/16

(52) U.S. Cl. CPC G02B 15/144113; G02B 13/16

(57) ABSTRACT

The present disclosure provides a zoom projection lens and an electronic device. The zoom projection lens includes: a first zoom lens group, a second zoom lens group, a compensation lens group, and a fixed lens group, sequentially along an optical axis direction from a zoom-in side to a zoom-out side; the first zoom lens group has a positive focal power, the second zoom lens group has a negative focal power, the compensation lens group has a positive focal power, and the fixed lens group has a positive focal power; and the first zoom lens group, the second zoom lens group, and the compensation lens group are movable along the optical axis.

### CROSS-REFERENCE TO RELATED APPLICATIONS

The present disclosure is a National Stage of International Application No. PCT/CN2022/102034, filed on Jun. 28, 2022, which claims priority to a Chinese patent application No. 202210475065.6 filed with the CNIPA on Apr. 29, 2022, both of which are hereby incorporated by reference in their entireties.

### TECHNICAL FIELD

The present disclosure relates to the technical field of optical devices, and particularly to a zoom projection lens and an electronic device.

### BACKGROUND

Projectors can be divided into CRT (Cathode Ray Tube) projectors, LCD (Liquid Crystal Display) projectors, DLP (Digital Light Processing) projectors, and LCoS (Liquid Crystal on Silicon) projectors. These projectors all utilize an optical projection method to project an image onto a large-sized screen. For example, a DLP projector uses a DMD (Digital Micromirror Device) as a light valve imager. The imaging principle thereof works by: controlling the reflection direction of light through the rotation of DMD micromirrors (±10°) to control the signal on-off state of that point, and then projecting the image formed on the DMD micromirror device onto the screen through optical lenses.

Many existing projectors possess zoom functions to adapt to different projection venues. This type of zoom projection lens typically includes a plurality of lens groups, achieving the zoom function by adjusting the relative positions of these lens groups to change the effective focal length of the zoom projection lens. However, if the distribution of focal power among the plurality of lens groups is uneven, it could influence the imaging quality of the zoom projection lens and fail to effectively correct field curvature characteristics and distortion characteristics.

### SUMMARY

An objective of the present disclosure is to provide a new technical solution for a zoom projection lens and an electronic device.

According to a first aspect of the present disclosure, a zoom projection lens is provided. Along an optical axis direction from a zoom-in side to a zoom-out side, the zoom projection lens sequentially includes: a first zoom lens group, a second zoom lens group, a compensation lens group, and a fixed lens group;
the first zoom lens group has a positive focal power, the second zoom lens group has a negative focal power, the compensation lens group has a positive focal power, and the fixed lens group has a positive focal power; and
the first zoom lens group, the second zoom lens group, and the compensation lens group are movable along the optical axis.

Optionally, lenses of the first zoom lens group, the second zoom lens group, the compensation lens group, and the fixed lens group are all spherical lenses.

Optionally, in a zooming process of the zoom projection lens from a short focus end to a long focus end, a first air gap between the first zoom lens group and the second zoom lens group gradually widens, a second air gap between the second zoom lens group and the compensation lens group gradually widens, and a third air gap between the compensation lens group and the fixed lens group gradually narrows.

Optionally, at the long focus end of the zoom projection lens, the zoom projection lens has a total optical length of TTL1, the first air gap has a width of d1, and the second air gap has a width of d2, satisfying the following formula: 0.25≤d1/TTL1≤0.3; 0.03≤d2/TTL1≤0.07.

Optionally, at the short focus end of the zoom projection lens, the zoom projection lens has a total optical length of TTL2 and the third air gap has a width of d3, satisfying the following formula: 0.04≤d3/TTL2≤0.06.

Optionally, the zoom projection lens has a working F-number, which satisfies: 1.6≤working F-number≤1.8.

Optionally, the first zoom lens group includes a first lens with a positive focal power and a second lens with a negative focal power.

Optionally, the second zoom lens group includes a third lens, a fourth lens and a fifth lens, the third lens has a negative focal power, and the fourth lens and the fifth lens has opposite focal powers.

Optionally, the zoom projection lens includes an aperture stop, which is located between the third lens and the fourth lens.

Optionally, the fourth lens and the fifth lens are cemented together to form a doublet lens.

Optionally, the compensation lens group includes a sixth lens and a seventh lens, which have opposite focal powers.

Optionally, the fixed lens group includes an eighth lens with a positive focal power.

Optionally, each of the first zoom lens group, the second zoom lens group, and the compensation lens group includes a cemented lens.

Optionally, effective focal lengths of the first zoom lens group, the second zoom lens group, the compensation lens group and the fixed lens group are f1, f2, f3, and f4 respectively, the zoom projection lens has a short focus end focal length of fw, which satisfies: 3.52≤f1/fw≤3.80, 1.41≤f2/fw≤1.17,1.41≤f3/fw≤1.64,2.96≤f4/fw≤3.19.

According to a second aspect of the present disclosure, an electronic device is provided. The electronic device includes the zoom projection lens according to the first aspect.

In the embodiments of the present disclosure, a zoom projection lens is provided. It limits the relative positional relationship of the first zoom lens group, the second zoom lens group, and the compensation fixing group and the fixed lens group, as well as the focal power of each lens group, thereby ensuring the imaging quality of the zoom projection lens.

Other features of the present disclosure and advantages thereof will become clear by the following detailed description of exemplary embodiments of the present disclosure with reference to the accompanying drawings.

### BRIEF DESCRIPTION OF THE DRAWINGS

In order to clearly illustrate embodiments of the present disclosure or technical solutions in the prior art, accompanying drawings that need to be used in description of the embodiments or the prior art will be briefly introduced as follows. Obviously, drawings in following description are only the embodiments of the present disclosure. For those skilled in the art, other drawings can also be obtained according to the disclosed drawings without creative efforts.

FIG. 1 illustrates a structural schematic diagram when a zoom projection lens of an embodiment of the present disclosure is at a long focus end.

FIG. 2 illustrates an optical path diagram when the zoom projection lens of an embodiment of the present disclosure is at the long focus end.

FIG. 3 illustrates a structural schematic diagram when a zoom projection lens of an embodiment of the present disclosure is at a short focus end.

FIG. 4 illustrates an optical path diagram when the zoom projection lens of an embodiment of the present disclosure is at the short focus end.

FIG. 5 illustrates a graph of air gap in a structural diagram of the zoom projection lens of an embodiment of the present disclosure.

FIG. 6 illustrates a modulation transfer function diagram when the zoom projection lens of an embodiment of the present disclosure is at the long focus end.

FIG. 7 illustrates an aberration characteristic graph when the zoom projection lens of an embodiment of the present disclosure is at the long focus end.

FIG. 8 illustrates a lateral chromatic aberration graph when the zoom projection lens of an embodiment of the present disclosure is at the long focus end.

FIG. 9 illustrates a modulation transfer function diagram when the zoom projection lens of an embodiment of the present disclosure is at the short focus end.

FIG. 10 illustrates an aberration characteristic graph when the zoom projection lens of an embodiment of the present disclosure is at the short focus end.

FIG. 11 illustrates a lateral chromatic aberration graph when the zoom projection lens of an embodiment of the present disclosure is at the short focus end.

FIG. 12 illustrates a modulation transfer function graph when the zoom projection lens of one embodiment is at the long focal length end.

FIG. 13 illustrates a modulation transfer function graph when the zoom projection lens of one embodiment is at the short focal length end.

FIG. 14 illustrates a modulation transfer function graph when the zoom projection lens of another embodiment is at the long focal length end.

FIG. 15 illustrates a modulation transfer function graph when the zoom projection lens of another embodiment is at the short focal length end.

FIG. 16 illustrates a modulation transfer function graph when the zoom projection lens of yet another embodiment is at the long focal length end.

FIG. 17 illustrates a modulation transfer function graph when the zoom projection lens of yet another embodiment is at the short focal length end.

### DESCRIPTION OF REFERENCE SIGNS

20. first zoom lens group; 1. first lens; 2. second lens;
30. second zoom lens group; 3. third lens; 9. aperture stop; 4. fourth lens; 5. fifth lens;
40. compensation lens group; 6. sixth lens; 7. seventh lens;
50. fixed lens group; 8. eighth lens;
10. first flat glass; 11. prism; 12. second flat glass; 13. image source.

### DETAILED DESCRIPTION

Various exemplary embodiments of the present disclosure will now be described in detail with reference to the accompanying drawings. It is to be noted that unless otherwise specified, the scope of present disclosure is not limited to relative arrangements, numerical expressions and values of components and steps as illustrated in the embodiments.

Description to at least one exemplary embodiment is for illustrative purpose only, and in no way implies any restriction on the present disclosure or application or use thereof.

Techniques, methods and devices known to those skilled in the prior art may not be discussed in detail; however, such techniques, methods and devices shall be regarded as part of the description where appropriate.

In all the examples illustrated and discussed herein, any specific value shall be interpreted as illustrative rather than restrictive. Different values may be available for alternative examples of the exemplary embodiments.

It is to be noted that similar reference numbers and alphabetical letters represent similar items in the accompanying drawings. In the case that a certain item is identified in a drawing, further reference thereof may be omitted in the subsequent drawings.

The present disclosure provides a zoom projection lens. Referring to FIGS. 1 to 5, along an optical axis direction from a zoom-in side to a zoom-out side, the zoom projection lens sequentially includes: a first zoom lens group 20, a second zoom lens group 30, a compensation lens group 40, and a fixed lens group 50. The first zoom lens group 20, the second zoom lens group 30, and the compensation lens group 40 are movable along the optical axis.

The first zoom lens group 20 has a positive focal power, the second zoom lens group 30 has a negative focal power, the compensation lens group 40 has a positive focal power, and the fixed lens group 50 has a positive focal power.

In the present embodiment, the first zoom lens group 20 and the second zoom lens group 30 are movably arranged along the optical axis to change the effective focal length of the zoom projection lens, achieving the zoom function while also allowing the compensation lens group 40 to move forward and backward for compensation. Thus, the first zoom lens group 20 and the second zoom lens group 30 move, which achieves a zoom from the short focus end to the long focus end while also ensuring a small change in the working F-number; the movement of the compensation lens group 40 primarily serves to change the position of the image plane in the zooming process, correct the aberrations and distortion of the system, and to ensure the uniformity of the image. Compared to the prior art where the lens group closest to the zoom-in side is a fixed lens group, the lens group closest to the zoom-in side is a movable group in the present embodiment, which makes focusing more flexible while ensuring imaging quality.

In the present embodiment, the lens group closest to the zoom-in side (the first zoom lens group) and the lens group second closest to the zoom-in side (the second zoom lens group) are both movable groups. By moving the two adjacent lens groups, the spacing between the two groups is changed, allowing for flexible focusing and thus achieving the zoom function. The compensation lens group is provided on the zoom-out side of the two zoom lens groups. After the two zoom lens groups are adjusted, the compensation lens group is moved to correct the clarity, distortion, and other characteristics of the imaging picture, thereby improving the imaging quality.

In the present embodiment, the first zoom lens group 20, the compensation lens group 40, and the fixed lens group 50 all have positive focal powers to converge light, the second zoom lens group 30 has a negative focal power to diverging light, and with combination of the first zoom lens group 20, the second zoom lens group 30, the compensation lens group 40, and the fixed lens group 50, it is possible to ensure consistency in imaging quality across the entire focal length range.

In the present embodiment, the present disclosure enhances the zoom ratio of the zoom projection lens by reasonably configuring the first zoom lens group 20, the second zoom lens group 30, the compensation lens group 40, and the fixed lens group 50, and by reasonably distributing the focal power of the first zoom lens group 20, the second zoom lens group 30, the compensation lens group 40, and the fixed lens group 50. For example, the zoom ratio of the zoom projection lens of the present disclosure may reach 1.5×.

In the present embodiment, the zoom projection lens further includes a first flat glass 10, a prism 11, a second flat glass 12, and an image source 13. In use, the fixed lens group 50 is disposed on the light-emergent side of the image source 13. In the present embodiment, the second flat glass 12 receives light exited from the image source 13 and the prism 11 receives light exited from the second flat glass 12. The first flat glass 10 receives the light exited from the prism 11 and the fixed lens group 50 receives the light exited from the first flat glass 10.

In the present embodiment, the image source 13 provides an image beam. The image source 13 is, for example, a reflective light modulator such as a Liquid Crystal On

Silicon panel (LCOS panel), Digital Micro-mirror Device (DMD), and the like. In other embodiments, the image source 13 may also be a penetrating light modulator such as a Transparent Liquid Crystal Panel, an Electro-Optical Modulator, a Magneto-Optic modulator, an Acousto-Optic Modulator (AOM), and the like.

In one embodiment, referring to FIGS. 1 to 4, lenses of the first zoom lens group 20, the second zoom lens group 30, the compensation lens group 40, and the fixed lens group 50 are all spherical lenses.

In the present embodiment, the lenses of the first zoom lens group 20, the second zoom lens group 30, the compensation lens group 40, and the fixed lens group 50 are all spherical lenses; that is, the lenses of the first zoom lens group 20 are spherical lenses, the lenses of the second zoom lens group 30 are spherical lenses, the lenses of the compensation lens group 40 are spherical lenses, and the lenses of the fixed lens group 50 are spherical lenses. In the prior art, the zoom projection lens includes at least one aspherical lens, or the lenses of the zoom projection lens are all aspherical lenses. The aspherical lenses have special surface geometries, which require higher production/measurement requirements as well as higher process costs.

Compared to the prior art, the lenses of the zoom projection lens of the present disclosure are all spherical lenses, which are rotationally symmetric optical elements with a constant distance between the curvature radius and the geometric center of the spherical lens. The parameter of the lens is constant on the whole surface, and the spherical lens has a more economical cost advantage in terms of processing and manufacturing. The present disclosure thus reduces the cost of the zoom projection lens. Since the parameters of the spherical lens are relatively uniform, the assembly difficulty is also reduced.

Therefore, in the present embodiment, the architecture and focal power of the first zoom lens group 20, the second zoom lens group 30, the compensation lens group 40, and the fixed lens group 50 are defined, as well as types of the lenses of the first zoom lens group 20, the second zoom lens group 30, the compensation lens group 40, and the fixed lens group 50, which reduces the cost and assembly difficulty of the zoom projection lens while ensuring the optical imaging quality. In the present embodiment, the lenses of the zoom projection lens are all spherical lenses, which have low manufacturing costs, high production yields, are not sensitive to temperature changes, and may operate in environments ranging from −40 to 80° C.

In one embodiment, referring to FIGS. 1 to 5, in the zooming process of the zoom projection lens from the short focus end to the long focus end, a first air gap between the first zoom lens group 20 and the second zoom lens group 30 gradually widens, a second air gap between the second zoom lens group 30 and the compensation lens group 40 gradually widens, and a third air gap between the compensation lens group 40 and the fixed lens group 50 gradually narrows.

In the present embodiment, referring to FIG. 5, in the zooming process of the zoom projection lens from the short focus end to the long focus end, the first air gap between the first zoom lens group 20 and the second zoom lens group 30 gradually widens. That is, when the zoom projection lens is at the short focus end (the shortest focal length), the first air gap between the first zoom lens group 20 and the second zoom lens group 30 is at its minimum; when the zoom projection lens is at the long focus end (the longest focal length), the first air gap between the first zoom lens group 20 and the second zoom lens group 30 is at its maximum. For example, it may be that the first zoom lens group 20 and the second zoom lens group 30 move towards each other, thereby shortening the first air gap; or the first zoom lens group 20 and the second zoom lens group 30 move away from each other, thereby increasing the first air gap.

Specifically, the first air gap between the first zoom lens group 20 and the second zoom lens group 30 is defined as: the air gap between two lenses that are provided adjacent to each other in the first zoom lens group 20 and the second zoom lens group 30. That is, referring to FIGS. 1 to 4, the first air gap between the first zoom lens group 20 and the second zoom lens group 30 is that the air gap between the second lens 2 and the third lens 3 is the first air gap.

In the present embodiment, referring to FIG. 5, in the zooming process of the zoom projection lens from the short focus end to the long focus end, the second air gap between the second zoom lens group 30 and the compensation lens group 40 gradually widens. That is, when the zoom projection lens is at the short focus end (the shortest focal length), the second air gap between the second zoom lens group 30 and the compensation lens group 40 is at its minimum; when the zoom projection lens is at the long focus end (the longest focal length), the second air gap between the second zoom lens group 30 and the compensation lens group 40 is at its maximum.

Specifically, the second air gap between the second zoom lens group 30 and the compensation lens group 40 is defined as: the air gap between two lenses that are provided adjacent to each other in the second zoom lens group 30 and the compensation lens group 40. That is, referring to FIGS. 1 to 4, the second air gap between the second zoom lens group 30 and the compensation lens group 40 is that the air gap between the fifth lens 5 and the sixth lens 6 is the second air gap.

In the present embodiment, referring to FIG. 5, in the zooming process of the zoom projection lens from the short focus end to the long focus end, the third air gap between the compensation lens group 40 and the fixed lens group 50 gradually reduces. That is, when the zoom projection lens is at the short focus end (the shortest focal length), the third air gap between the compensation lens group 40 and the fixed lens group 50 is at its maximum; when the zoom projection lens is at the long focus end (the longest focal length), the third air gap between the compensation lens group 40 and the fixed lens group 50 is at its minimum.

Specifically, the third air gap between the compensation lens group 40 and the fixed lens group 50 is defined as: the air gap between two lenses that are provided adjacent to each other in the compensation lens group 40 and the fixed lens group 50. That is, referring to FIGS. 1 to 4, the third air gap between the compensation lens group 40 and the fixed lens group 50 is that the air gap between the seventh lens 7 and the eighth lens 8 is the third air gap.

In the present embodiment, changes of the first air gap, the second air gap, and the third air gap in the zoom projection lens are defined, and the first zoom lens group 20 and the second zoom lens group 30 may move along the optical axis for achieving the change of the zoom projection lens in the present embodiment from short focus to long focus. The compensation lens group in the present embodiment may move along the optical axis for compensating for changes in the position of the image plane during the optical zooming process.

Referring to FIG. 5, movement curves of the first zoom lens group 20, the second zoom lens group 30, and the compensation lens group 40 are cam curves without any abrupt changes. During use of the zoom projection lens, grooves are formed on the inner surface of the lens barrel (grooves for the movement of the first zoom lens group 20, the second zoom lens group 30, and the compensation lens group 40), leading to strong machinability.

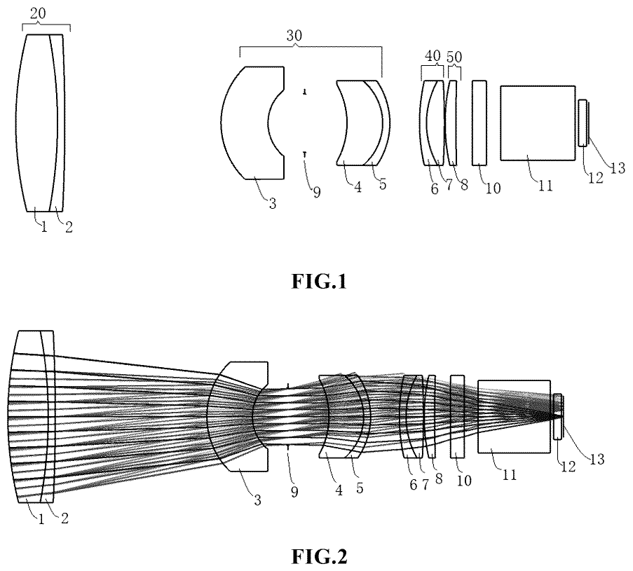

In an embodiment, referring to FIGS. 1 and 2, at the long focus end of the zoom projection lens, the zoom projection lens has a total optical length of TTL1, the first air gap has a width of d1, and the second air gap has a width of d2, satisfying the following formula: 0.25≤d1/TTL1≤0.3; 0.03≤d2/TTL1≤0.07.

In the present embodiment, when the zoom projection lens is in the long focus mode, the first air gap between the first zoom lens group 20 and the second zoom lens group 30 accounts for 25% to 30% of the optical total length of the zoom projection lens, and the second air gap between the second zoom lens group 30 and the compensation lens group 40 accounts for 3% to 7% of the optical total length of the zoom projection lens. In a specific embodiment, the value of d1/TTL1 may be: 0.25, 0.26, 0.27, 0.28, 0.29, 0.30. The value of d2/TTL1 may be: 0.03, 0.04, 0.05, 0.06, 0.07.

In the present embodiment, by defining the ratio of the first air gap to the optical total length TTL1, as well as the ratio of the second air gap to the optical total length TTL1, it is possible to reduce the length of the optical total length TTL1 and thereby reduce the volume of the zoom projection lens while ensuring the quality of optical imaging.

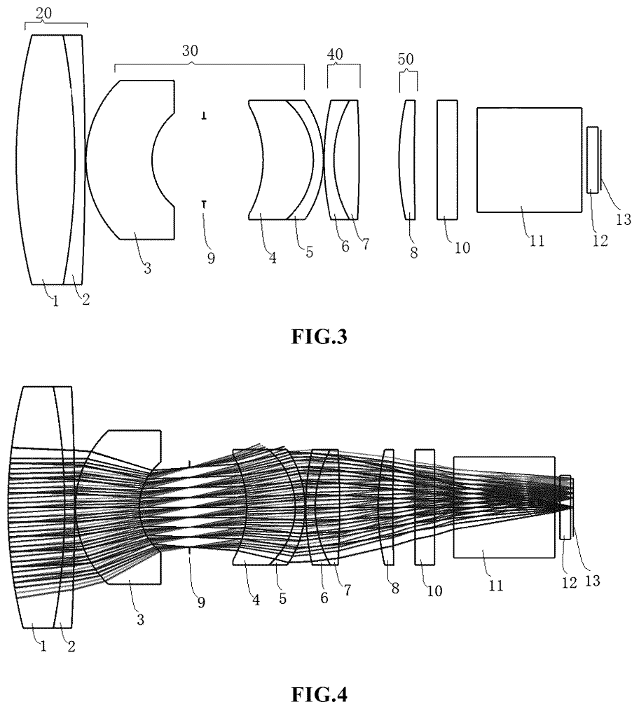

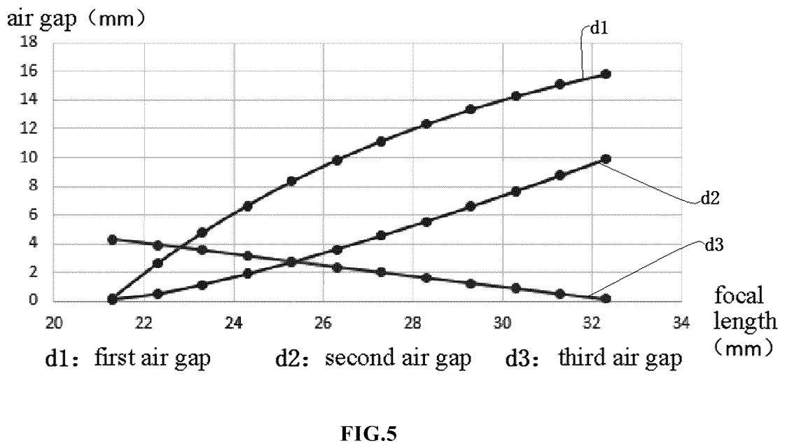

In an embodiment, referring to FIGS. 3 and 4, at the short focus end of the zoom projection lens, the zoom projection lens has a total optical length of TTL2 and the third air gap has a width of d3, satisfying the following formula: 0.04≤d3/TTL2≤0.06.

In the present embodiment, when the zoom projection lens is in the short focus mode, the third air gap between the compensation lens group 40 and the fixed lens group 50 accounts for 4% to 6% of the optical total length of the zoom projection lens. In a specific embodiment, the value of d3/TTL2 may be: 0.04, 0.05, 0.06.

In the present embodiment, by defining the ratio of the third air gap to the optical total length TTL2, it is possible to reduce the length of the optical total length TTL2 and thereby reduce the volume of the zoom projection lens while ensuring the quality of optical imaging.

In an embodiment, the zoom projection lens has a working F-number, which satisfies: 1.6≤working F-number≤1.8.

Specifically, the working F-number (also known as the working F-value) refers to a relative value obtained by dividing the focal length of the zoom projection lens by the entrance pupil diameter of the lens in the working state. The smaller the working F-number, the more light is admitted in the same unit of time. The larger the working F-number, the shallower the depth of field, which is similar to the effect of a telephoto lens.

Referring to FIGS. 1 to 4, in the present embodiment, the movement of the first zoom lens group 20 and the second zoom lens group 30 affects the entrance pupil diameter, which is not constant. Through the variation of the focal length of the zoom projection lens and the variation of the entrance pupil diameter, the ratio of the focal length to the entrance pupil diameter of the lens is within a predetermined range. Additionally, the present embodiment may also ensure a constant working F-number by compensating for the movement of the projection group.

Therefore, in the present embodiment, in the zooming process of the zoom projection lens from the short focus end to the long focus end, the working F-number of the zoom projection lens does not vary with the change in focal length and is maintained within 1.7±0.1, which design ensures consistent light intake for the zoom projection lens and maintains the brightness of the projected image.

In an embodiment, referring to FIGS. 1 to 4, the first zoom lens group 20 includes a first lens 1 with a positive focal power and a second lens 2 with a negative focal power.

In the present embodiment, the first zoom lens group 20 includes only two lenses, namely the first lens 1 and the second lens 2. The focal power of the first lens 1 is positive, with both its first and second surfaces being convex; the focal power of the second lens 2 is negative, with its first surface being concave and its second surface being convex. In the present embodiment, the focal length of the first lens 1 ranges from 100 mm to 105 mm, and the focal length of the second lens 2 ranges from 1500 mm to 1600 mm. Specifically, the first surface refers to the surface close to the zoom-in side, and the second surface refers to the surface far from the zoom-in side.

In the present embodiment, by defining the focal power of the first lens 1 and the second lens 2 and reasonably distributing the focal power of the first lens 1 and the second lens 2, it is possible to enable the overall focal power of the first zoom lens group 20 to be positive to ensure that the first zoom lens group 20, when cooperating with the second zoom lens group 30 and the compensation lens group 40 to realize zoom, may ensure a high definition of the imaging quality in the zooming range.

In an embodiment, referring to FIGS. 1 to 4, the second zoom lens group 30 includes a third lens 3, a fourth lens 4 and a fifth lens 5, the third lens 3 has a negative focal power, and the fourth lens 4 and the fifth lens 5 has opposite focal powers.

In the present embodiment, the second zoom lens group 30 includes only three lenses, namely the third lens 3, the fourth lens 4, and the fifth lens 5. The third lens 3 has a negative focal power, with its first surface being convex and its second surface being concave; the fourth lens 4 and the fifth lens 5 have opposite focal powers. Specifically, the first surface refers to the surface close to the zoom-in side, and the second surface refers to the surface far from the zoom-in side. In the present embodiment, the focal length of the third lens 3 ranges from −18 mm to −15 mm; the focal length of the fourth lens 4 ranges from −15 mm to −12 mm; and the focal length of the fifth lens 5 ranges from 14 mm to 16 mm.

In the present embodiment, by defining the focal power of the third lens 3, the fourth lens 4 and the fifth lens 5, and reasonably distributing the focal power of the third lens 3, the fourth lens 4 and the fifth lens 5, it is possible to enable the overall focal power of the second zoom lens group 30 to be negative to ensure that the second zoom lens group 30, when cooperating with the first zoom lens group 20 and the compensation lens group 40 to realize zoom, may ensure a high definition of the imaging quality in the zooming range.

In an embodiment, referring to FIGS. 1 to 4, the zoom projection lens includes an aperture stop 9, which is located between the third lens 3 and the fourth lens 4.

In the present embodiment, the aperture stop 9 is located in the second zoom lens group 30 and moves along with the second zoom lens group 30, which affects the imaging quality. By providing the compensation lens group 40 on the zoom-out side of the second zoom lens group 30, the present embodiment compensates for defects in imaging picture due to movement of the stop in the second zoom lens group 30 by movement of the compensation lens group 40.

In an embodiment, referring to FIGS. 1 to 4, the fourth lens 4 and the fifth lens 5 are cemented together to form a doublet lens.

In the present embodiment, in the second zoom lens group 30, a set of doublet lens is located on the zoom-out side of the stop to reduce chromatic aberration in imaging.

Specifically, the fourth lens 4 and the fifth lens 5 are cemented together to form a doublet lens. The fourth lens 4 and the fifth lens 5 have opposite focal powers, wherein the refractive index of the lens with a positive focal power is lower than that of the lens with a negative focal power.

In an embodiment, referring to FIGS. 1 to 4, the compensation lens group 40 includes a sixth lens 6 and a seventh lens 7, which have opposite focal powers.

In the present embodiment, the compensation lens group 40 includes only two lenses, namely the sixth lens 6 and the seventh lens 7. In a specific embodiment, the sixth lens 6 has a negative focal power, with its first surface being convex and its second surface being concave; the seventh lens 7 has a positive focal power, with both its first and second surfaces being convex. Specifically, the first surface refers to the surface close to the zoom-in side, and the second surface refers to the surface far from the zoom-in side. In the present embodiment, the focal length of the sixth lens 6 ranges from 39 mm to 42 mm; the focal length of the seventh lens 7 ranges from −420 to −400.

In the present embodiment, by defining the focal power of the sixth lens 6 and the seventh lens 7 and reasonably distributing the focal power of the sixth lens 6 and the seventh lens 7, it is possible to enable the overall focal power of the compensation lens group 40 to be positive, to ensure that the compensation lens group 40, when cooperating with the first zoom lens group 20 and the second zoom lens group 30 to realize zoom, may ensure a high definition of the imaging quality in the zooming range.

In an embodiment, referring to FIGS. 1 to 4, the fixed lens group 50 includes an eighth lens 8 with a positive focal power.

Specifically, the fixed lens group 50 is fixedly disposed with respect to the first zoom lens group 20, the second zoom lens group 30, and the compensation lens group 40. In the present embodiment, the fixed lens group 50 includes only one lens, namely, the eighth lens 8. The focal power of the eighth lens 8 is positive, with its first surface being convex and its second surface being flat. Specifically, the first surface refers to a surface close to the zoom-in side, and the second surface refers to a surface far from the zoom-in side. In the present embodiment, the focal length of the eighth lens 8 ranges from 60 mm to 65 mm.

In an embodiment, referring to FIGS. 1 to 4, each of the first zoom lens group 20, the second zoom lens group 30, and the compensation lens group 40 includes a cemented lens.

In the present embodiment, in the first zoom lens group 20, the first lens 1 and the second lens 2 are cemented together. In the second zoom lens group 30, the fourth lens 4 and the fifth lens 5 are cemented together. In the compensation lens group 40, the sixth lens 6 and the seventh lens 7 are cemented together.

Specifically, the first lens 1 and the second lens 2 are cemented together, and the sixth lens 6 and the seventh lens 7 are cemented together, which may reduce the total optical length of the zoom projection lens. Specifically, the fourth lens 4 and the fifth lens 5 are cemented together, which may correct the chromatic aberration in imaging.

In a specific embodiment, referring to FIGS. 1 to 4, the zoom projection lens includes the first lens 1, the second lens 2, the third lens 3, the stop, the fourth lens 4, the fifth lens 5, the sixth lens 6, the seventh lens 7, and the eighth lens 8. The zoom projection lens includes only eight lenses, and defines the focal power and lens type of the eight lenses, which reduces the cost while ensuring the imaging quality.

In an embodiment, effective focal lengths of the first zoom lens group 20, the second zoom lens group 30, the compensation lens group 40 and the fixed lens group 50 are f1, f2, f3, and f4 respectively, the zoom projection lens has a short focus end focal length of fw, which satisfies: 3.52≤f1/fw≤3.80, −1.41≤f2/fw≤−1.17, 1.41≤f3/fw≤1.64, 2.96≤f4/fw≤3.19.

In the present embodiment, by defining the zoom projection lens based on the above conditions, the zoom projection lens adjusts the zoom by movement of the two zooming groups and one compensation group. By reasonably distributing the focal power of the zoom projection lens and defining the effective focal length based on the above condition, on the one hand, it is possible to ensure that the zoom projection lens has a high resolution in the zooming range; on the other hand, by reasonably distributing the focal power and focal length of the zoom projection lens based on the above conditions, the zoom projection lens has a high zooming ratio. For example, in the present embodiment, the zoom projection lens may achieve zoom projection of 1.5×.

In the present embodiment, the effective focal length of the first zoom lens group 20 ranges from 75 mm to 81 mm; the effective focal length of the second zoom lens group 30 ranges from −30 mm to −25 mm; the effective focal length of the compensation lens group 40 ranges from 30 mm to 35 mm; the effective focal length of the fixed lens group 50 ranges from 63 mm to 68 mm. In the present embodiment, when the zoom projection lens is at the short focus end, the shortest focal length is 21.3 mm, and when the zoom projection lens is at the long focus end, the longest focal length is 32.3 mm.

The zoom projection lens provided by the present embodiment has the following characteristics:
1) By reasonably distributing the focal power of the lens groups, the zoom projection lens has a larger zooming ratio. For example, the zooming ratio of the zoom projection lens of the present disclosure is 1.5×.
2) By defining the structure of the zoom projection lens, the zoom projection lens may project a clear picture at a distance of 2 meters, and may ensure a clear picture within the range of 1.5 to 4 meters by adjusting the rear focus of the lens.
3) Through the combination of the above lens groups, the zoom projection lens has a low level of distortion. For example, the distortion range of the zoom projection lens of the present disclosure is less than 1%.
4) System focal length: 21.3 mm-32.3 mm; field of view: 5°-8.5°; image circle diameter: 5.5 mm-6.5 mm; system F-number: 1.65-1.75.

According to a second aspect of the present disclosure, an electronic device is provided. The electronic device includes the zoom projection lens of the first aspect.

In the present embodiment, the zoom projection lens is applied to the electronic device. For example, the electronic device may be a projector. By applying the zoom projection lens to the projector, the projector has a high zoom zoom-in, as well as good imaging quality.

### Embodiment One

Referring to FIGS. 1 to 4, from a zoom-in side to a zoom-out side, the zoom projection lens includes a first lens 1, a second lens 2, a third lens 3, a fourth lens 4, a sixth lens 6, a seventh lens 7, an eighth lens 8, a first flat glass 10, a prism 11, a second flat glass 12, and an image source 13.

Specifically, an aperture stop 9 is provided between the third lens 3 and the fourth lens 4. The first lens 1 and the second lens 2 are cemented together, the fourth lens 4 and the fifth lens 5 are cemented together, and the sixth lens 6 and the seventh lens 7 are cemented together. From the zoom-in side to the zoom-out side, the focal power of the zoom projection lens is arranged in an order of: positive, negative, negative/negative, positive, negative, positive, positive.

In the present embodiment, the first lens 1, the second lens 2, the third lens 3, the fourth lens 4, the sixth lens 6, the seventh lens 7, and the eighth lens 8 are all spherical lenses. The zoom lens system of embodiments of the present disclosure has a small number of lenses, all of which are spherical lenses, and by adjusting the imaging picture with the compensation lens group 40, it is possible to reduce the cost and assembly difficulty.

In the present embodiment, the first lens 1 and the second lens 2 are cemented into a glass cemented lens; the fourth lens 4 and the fifth lens 5 are cemented into a glass cemented lens; the sixth lens 6 and the seventh lens 7 are cemented into a glass cemented lens; the remaining lenses are all glass spherical lenses.

In the present embodiment, the zoom projection lens uses eight lenses to form four lens groups, and the zoom function is achieved by adjusting relative positions of the first zoom lens group, the second zoom lens group, and the compensation lens group. Therefore, the zoom projection lens of the present disclosure may balance optical imaging quality, cost, and assembly ease.

In the present embodiment, the focal length of the first lens 1 ranges from 100 mm to 105 mm; the focal length of the second lens 2 ranges from 1500 mm to 1600 mm; the focal length of the third lens 3 ranges from −18 mm to −15 mm; the focal length of the fourth lens 4 ranges from −15 mm to −12 mm; the focal length of the fifth lens 5 ranges from 14 mm to 16 mm; the focal length of the sixth lens 6 ranges from 39 mm to 42 mm; the focal length of the seventh lens 7 ranges from −420 mm to −400 mm; the focal length of the eighth lens 8 ranges from 60 mm to 65 mm.

In the present embodiment, the effective focal length of the first zoom lens group 20 ranges from 75 mm to 81 mm; the effective focal length of the second zoom lens group 30 ranges from −30 mm to −25 mm; the effective focal length of the compensation lens group 40 ranges from 30 mm to 35 mm; the effective focal length of the fixed lens group 50 ranges from 63 mm to 68 mm.

In the present embodiment, the zoom projection lens has a system focal length of 21.3 mm (short focus end)-32.3 mm (long focus end) and a zooming ratio of 1.5×.

The zoom projection lens provided by the present embodiment may project a clear picture at a distance of 2 meters, and may ensure a clear picture in the range of 1.5 to 4 meters by adjusting the rear focus of the lens.

The field of view of the zoom projection lens: 5°-8.5°; the image circle diameter: 5.5 mm-6.5 mm; the system F-number: 1.65-1.75.

The present system is suitable for 0.23″ DMD TR 4-6 design. That is, the embodiment of the present disclosure constructs an optical architecture suitable for 0.23″ DMD TR 4-6 by using eight lenses, which compared to the prior art, reduces the number of lenses used as well as the volume of the zoom projection lens.

Specifically, as shown in FIG. 1, the surface of the first lens 1 close to the zoom-in side is the convex surface, and the surface far from the zoom-in side is also the convex surface; the surface of the second lens 2 close to the zoom-in side is the concave surface, and the surface far from the zoom-in side is the convex surface; the surface of the third lens 3 close to the zoom-in side is the convex surface, and the surface far from the zoom-in side is the concave surface; the surface of the fourth lens 4 close to the zoom-in side is the concave surface, and the surface far from the zoom-in side is the convex surface; the surface of the fifth lens 5 close to the zoom-in side is the concave surface, and the surface far from the zoom-in side is the convex surface; the surface of the sixth lens 6 close to the zoom-in side is the convex surface, and the surface far from the zoom-in side is the concave surface; the surface of the seventh lens 7 close to the zoom-in side is the convex surface, and the surface far from the zoom-in side is the convex surface; the surface of the eighth lens 8 close to the zoom-in side is the convex surface, and the surface far from the zoom-in side is a flat surface.

The characteristic parameters of each lens and the aperture stop 9 are shown in Table 1 and Table 2. Specifically, Table 1 shows the curvature radius, thickness, refractive index, and Abbe number corresponding to each lens and the aperture stop 9 when the zoom projection lens is at the long focus end. Table 2 shows the curvature radius, thickness, refractive index, and Abbe number corresponding to each lens and the aperture stop 9 when the zoom projection lens is at the short focus end.

Specifically, in Tables 1 and 2, the thickness represents the axial distance from the corresponding surface to the next surface; Nd is the refractive index of the d-light (wavelength of 587 nanometers, same below) for the corresponding lens; Vd is the Abbe number of the d-light for the corresponding lens.

TABLE 1

| | curvature | | refractive | Abbe |
|---|---|---|---|---|
| serial | radius mm | thickness mm | index | number |
| number | (Radius) | (Thickness) | (Nd) | (Vd) |
| 1/2 | 50.48 | 5.87 | 1.6 | 65.5 |
| | −67.2 | 1.03 | | |
| | −249 | 22.1(variable air | 1.76 | 26.6 |
| | | gap) | | |
| 3 | 11.02 | 6.12 | 1.81 | 25.5 |
| | 6.06 | 5.19 | | |
| 9 | infinity | 5.95 | / | / |
| 4/5 | −11.3 | 5.03 | 1.73 | 54.7 |
| | −7.86 | 1.01 | | |
| | −10.58 | 4.18 (variable air | 1.81 | 25.5 |
| | | gap) | | |
| 6/7 | 26.64 | 0.98 | 1.9 | 31.3 |
| | 12.19 | 2.53 | | |
| | −107.98 | 0.1 (variable air | 1.79 | 47.5 |
| | | gap) | | |
| 8 | 27.06 | 1.52 | 1.5 | 81.6 |
| | 205.6 | 2.3 | | |

TABLE 2

| | curvature | | refractive | Abbe |
|---|---|---|---|---|
| serial | radius mm | thickness mm | index | number |
| number | (Radius) | (Thickness) | (Nd) | (Vd) |
| 1/2 | 50.48 | 5.87 | 1.6 | 65.5 |
| | −67.2 | 1.03 | | |
| | −249 | 0.09 (variable air | 1.76 | 26.6 |
| | | gap) | | |
| 3 | 11.02 | 6.12 | 1.81 | 25.5 |
| | 6.06 | 5.19 | | |
| 9 | infinity | 5.95 | / | / |
| 4/5 | −11.3 | 5.03 | 1.73 | 54.7 |
| | −7.86 | 1.01 | | |
| | −10.58 | 0.07 (variable air | 1.81 | 25.5 |
| | | gap) | | |
| 6/7 | 26.64 | 0.98 | 1.9 | 31.3 |
| | 12.19 | 2.53 | | |
| | −107.98 | 4 (variable air | 1.79 | 47.5 |
| | | gap) | | |
| 8 | 27.06 | 1.52 | 1.5 | 81.6 |
| | 205.6 | 2.3 | | |

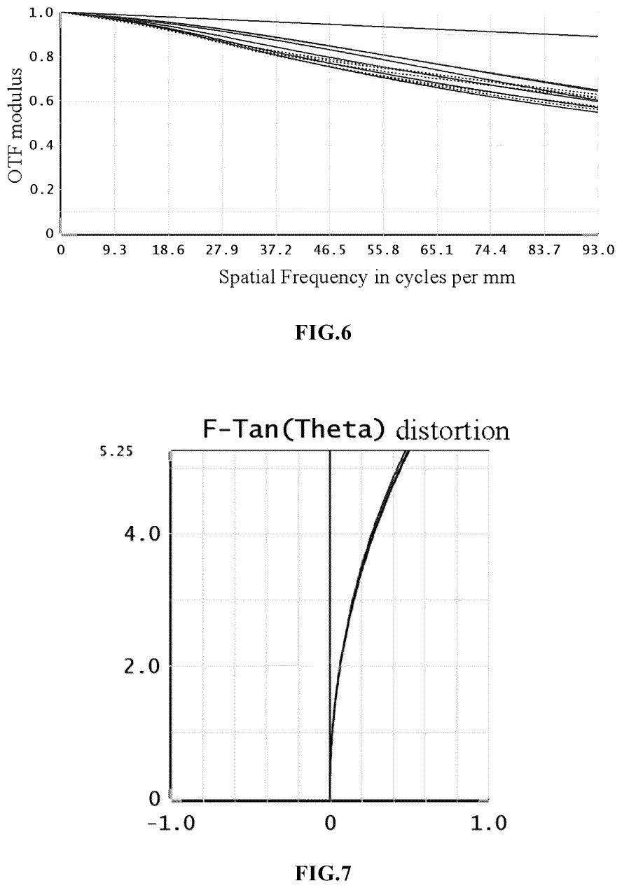

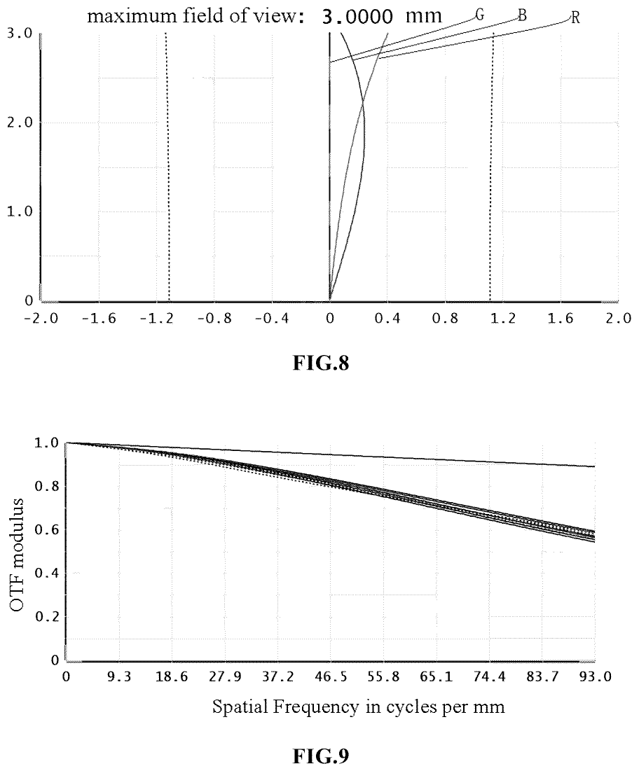

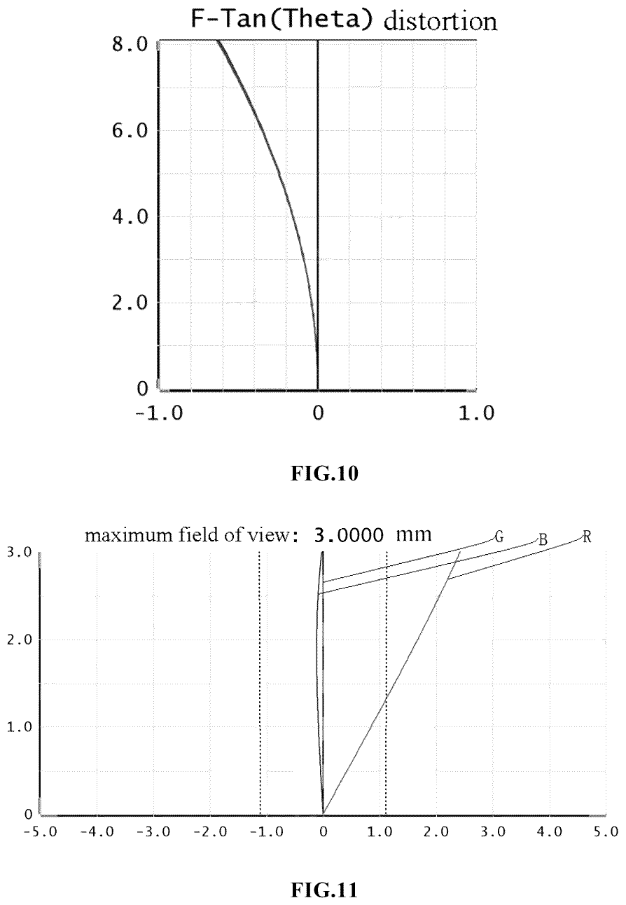

FIG. 6 illustrates a modulation transfer function diagram when the zoom projection lens shown in the present embodiment is at the long focus end. FIG. 7 illustrates an aberration characteristic graph when the zoom projection lens shown in the present embodiment is at the long focus end. FIG. 8 illustrates a lateral chromatic aberration characteristic graph when the zoom projection lens shown in the present embodiment is at the long focus end. FIG. 9 illustrates a modulation transfer function diagram when the zoom projection lens shown in the present embodiment is at the short focus end. FIG. 10 illustrates an aberration characteristic graph when the zoom projection lens shown in the present embodiment is at the short focus end. FIG. 11 illustrates a lateral chromatic aberration characteristic graph when the zoom projection lens shown in the present embodiment is at the short focus end.

Referring to FIG. 6, wherein the horizontal axis represents spatial frequency (Spatial Frequency in cycles per mm), and the vertical axis represents the modulus of the OTF. As can be seen from FIG. 6 that in the spatial frequency of 0 to 93 mm, the modulus value of the OTF may always be kept above 0.55. Generally speaking, the closer the modulus value of the OTF is to 1, the higher the quality of the image. However, due to various factors, there is no situation where the modulus value of the OTF is 1. Generally, when the modulus value of the OTF may be kept above 0.55, it indicates that the image has a very high imaging quality, and an excellent clarity. Therefore, it can be concluded that the zoom projection lens in the present embodiment has a higher imaging quality.

Referring to FIG. 7, the distortion is controlled within the range of (0, 0.5%), and the distortion is small.

Referring to FIG. 8, at the maximum field of view of 3.0000 mm, the lateral chromatic aberration is less than 0.4 μm.

Referring to FIG. 9, wherein the horizontal axis represents spatial frequency (Spatial Frequency in cycles per mm), and the vertical axis represents the modulus of the OTF. As can be seen from FIG. 9 that in the spatial frequency of 0 to 93 mm, the modulus value of the OTF may always be kept above 0.53. Generally speaking, the closer the modulus value of the OTF is to 1, the higher the quality of the image. However, due to various factors, there is no situation where the modulus value of the OTF is 1. Generally, when the modulus value of the OTF may be kept above 0.53, it indicates that the image has a very high imaging quality, and an excellent clarity. Therefore, it can be concluded that the zoom projection lens in the present embodiment has a higher imaging quality.

Referring to FIG. 10, the distortion is controlled within the range of (−0.6%, 0), and the distortion is small.

Referring to FIG. 11, at the maximum field of view of 3.0000 mm, the lateral chromatic aberration is less than 2.4 μm.

In summary, the field curvature, distortion, and lateral chromatic aberration produced by the zoom projection lens in its zooming range are controlled (corrected) within a small range. The zoom projection lens exhibits good imaging quality.

### Embodiment Two

Embodiment Two differs from Embodiment One in that there are differences in the curvature radius and thickness dimensions of each lens.

In the present embodiment, the characteristic parameters of each lens and the aperture stop 9 are shown in Table 3 and Table 4. Specifically, Table 3 shows the curvature radius, thickness, refractive index, and Abbe number corresponding to each lens and the aperture stop 9 when the zoom projection lens is at the long focus end. Table 4 shows the curvature radius, thickness, refractive index, and Abbe number corresponding to each lens and the aperture stop 9 when the zoom projection lens is at the short focus end. Specifically, in Tables 3 and 4, the thickness represents the axial distance from the corresponding surface to the next surface; Nd is the refractive index of the d-light (wavelength of 587 nanometers, same below) for the corresponding lens; Vd is the Abbe number of the d-light for the corresponding lens.

TABLE 3

| | curvature | | refractive | Abbe |
|---|---|---|---|---|
| serial | radius mm | thickness mm | index | number |
| number | (Radius) | (Thickness) | (Nd) | (Vd) |
| 1/2 | 45 | 3.9 | 1.6 | 65.5 |
| | −72.9 | 1.02 | | |
| | −341 | 20.2 (variable air | 1.76 | 26.6 |
| | | gap) | | |
| 3 | 11.55 | 7.1 | 1.81 | 25.5 |
| | 6.1 | 5.2 | | |
| 9 | infinity | 5.55 | / | / |
| 4/5 | −11.06 | 5.33 | 1.73 | 54.7 |
| | −7.86 | 0.98 | | |
| | −10.6 | 4.4 (variable air | 1.81 | 25.5 |
| | | gap) | | |
| 6/7 | 26.88 | 0.9 | 1.9 | 31.3 |
| | 12.6 | 2.84 | | |
| | −85 | 0.1 (variable air | 1.79 | 47.5 |
| | | gap) | | |
| 8 | 28.2 | 1.44 | 1.5 | 81.6 |
| | 180 | 2.3 | | |

TABLE 4

| | curvature | | refractive | Abbe |
|---|---|---|---|---|
| serial | radius mm | thickness mm | index | number |
| number | (Radius) | (Thickness) | (Nd) | (Vd) |
| 1/2 | 45 | 3.9 | 1.6 | 65.5 |
| | −72.9 | 1.02 | | |
| | −341 | 0.09 (variable | 1.76 | 26.6 |
| | | air gap) | | |
| 3 | 11.55 | 7.1 | 1.81 | 25.5 |
| | 6.1 | 5.2 | | |
| 9 | infinity | 5.55 | / | / |
| 4/5 | −11.06 | 5.33 | 1.73 | 54.7 |
| | −7.86 | 0.98 | | |
| | −10.6 | 0.06 (variable | 1.81 | 25.5 |
| | | air gap) | | |
| 6/7 | 26.88 | 0.9 | 1.9 | 31.3 |
| | 12.6 | 2.84 | | |
| | −85 | 4.01 (variable | 1.79 | 47.5 |
| | | air gap) | | |
| 8 | 28.2 | 1.44 | 1.5 | 81.6 |
| | 180 | 2.3 | | |

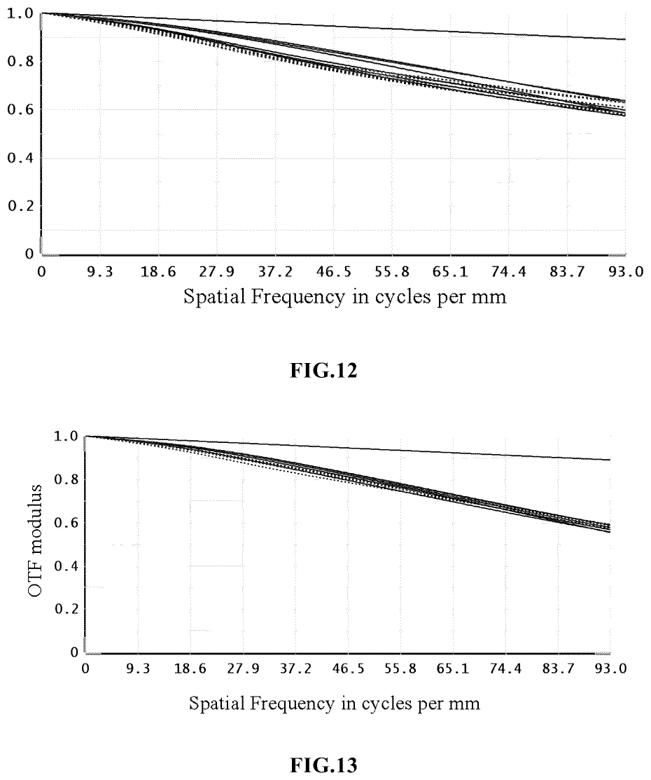

FIG. 12 illustrates a modulation transfer function graph when the zoom projection lens shown in the present embodiment is at the long focal length end. FIG. 13 illustrates a modulation transfer function graph when the zoom projection lens shown in the present embodiment is at the short focal length end.

Referring to FIG. 12, wherein the horizontal axis represents spatial frequency (Spatial Frequency in cycles per mm), and the vertical axis represents the modulus of the OTF. As can be seen from FIG. 12 that in the spatial frequency of 0 to 93 mm, the modulus value of the OTF may always be kept above 0.57. Generally speaking, the closer the modulus value of the OTF is to 1, the higher the quality of the image. However, due to various factors, there is no situation where the modulus value of the OTF is 1. Generally, when the modulus value of the OTF may be kept above 0.57, it indicates that the image has a very high imaging quality, and an excellent clarity. Therefore, it can be concluded that the zoom projection lens in the present embodiment has a higher imaging quality.

Referring to FIG. 13, wherein the horizontal axis represents spatial frequency (Spatial Frequency in cycles per mm), and the vertical axis represents the modulus of the OTF. As can be seen from FIG. 13 that in the spatial frequency of 0 to 93 mm, the modulus value of the OTF may always be kept above 0.55. Generally speaking, the closer the modulus value of the OTF is to 1, the higher the quality of the image. However, due to various factors, there is no situation where the modulus value of the OTF is 1. Generally, when the modulus value of the OTF may be kept above 0.55, it indicates that the image has a very high imaging quality, and an excellent clarity. Therefore, it can be concluded that the zoom projection lens in the present embodiment has a higher imaging quality.

In the present embodiment, the zoom projection lens has a system focal length of 21.3 mm (short focus end)-32.3 mm (long focus end) and a zooming ratio of 1.5×.

The present design may project a clear picture at a distance of 2 meters, and may ensure a clear picture in the range of 1.5 to 4 meters by adjusting the rear focus of the lens.

The field of view of the zoom projection lens: 5°-8.5°; the image circle diameter: 5.5 mm-6.5 mm; the system F-number: 1.65-1.75.

The present system is suitable for 0.23″ DMD TR 4-6 design. That is, the embodiment of the present disclosure constructs an optical architecture suitable for 0.23″ DMD TR 4-6 by using eight lenses, which compared to the prior art, reduces the number of lenses used as well as the volume of the zoom projection lens.

In summary, the distortion produced by the zoom projection lens in its zooming range is controlled (corrected) within a small range. The zoom projection lens exhibits good imaging quality.

### Embodiment Three

Embodiment Three differs from Embodiment One in that there are differences in the curvature radius and thickness dimensions of each lens.

In the present embodiment, the characteristic parameters of each lens and the aperture stop 9 are shown in Table 5 and Table 6. Specifically, Table 5 shows the curvature radius, thickness, refractive index, and Abbe number corresponding to each lens and the aperture stop 9 when the zoom projection lens is at the long focus end. Table 6 shows the curvature radius, thickness, refractive index, and Abbe number corresponding to each lens and the aperture stop 9 when the zoom projection lens is at the short focus end.

Specifically, in Tables 5 and 6, the thickness represents the axial distance from the corresponding surface to the next surface; Nd is the refractive index of the d-light (wavelength of 587 nanometers, same below) for the corresponding lens; Vd is the Abbe number of the d-light for the corresponding lens.

TABLE 5

| | curvature | | refractive | Abbe |
|---|---|---|---|---|
| serial | radius mm | thickness mm | index | number |
| number | (Radius) | (Thickness) | (Nd) | (Vd) |
| 1/2 | 48 | 3.86 | 1.6 | 65.5 |
| | −72 | 1.03 | | |
| | −302 | 21.5 (variable air | 1.76 | 26.6 |
| | | gap) | | |
| 3 | 11.73 | 7.3 | 1.81 | 25.5 |
| | 6.2 | 5.51 | | |
| 9 | infinity | 5.76 | / | / |
| 4/5 | 11.3 | 5.16 | 1.73 | 54.7 |
| | −7.9 | 0.96 | | |
| | −10.7 | 4.12 (variable air | 1.81 | 25.5 |
| | | gap) | | |
| 6/7 | 27.8 | 0.99 | 1.9 | 31.3 |
| | 12.7 | 2.78 | | |
| | −80 | 0.1 (variable air | 1.79 | 47.5 |
| | | gap) | | |
| 8 | 26.8 | 1.57 | 1.5 | 81.6 |
| | 157.8 | 2.3 | | |

TABLE 6

| | curvature | | refractive | Abbe |
|---|---|---|---|---|
| serial | radius mm | thickness mm | index | number |
| number | (Radius) | (Thickness) | (Nd) | (Vd) |
| 1/2 | 48 | 3.86 | 1.6 | 65.5 |
| | −72 | 1.03 | | |
| | −302 | 0.09 (variable air | 1.76 | 26.6 |
| | | gap) | | |
| 3 | 11.73 | 7.3 | 1.81 | 25.5 |
| | 6.2 | 5.51 | | |
| 9 | infinity | 5.76 | / | / |
| 4/5 | 11.3 | 5.16 | 1.73 | 54.7 |
| | −7.9 | 0.96 | | |
| | −10.7 | 0.07 (variable air | 1.81 | 25.5 |
| | | gap) | | |
| 6/7 | 27.8 | 0.99 | 1.9 | 31.3 |
| | 12.7 | 2.78 | | |
| | −80 | 3.94 (variable air | 1.79 | 47.5 |
| | | gap) | | |
| 8 | 26.8 | 1.57 | 1.5 | 81.6 |
| | 157.8 | 2.3 | | |

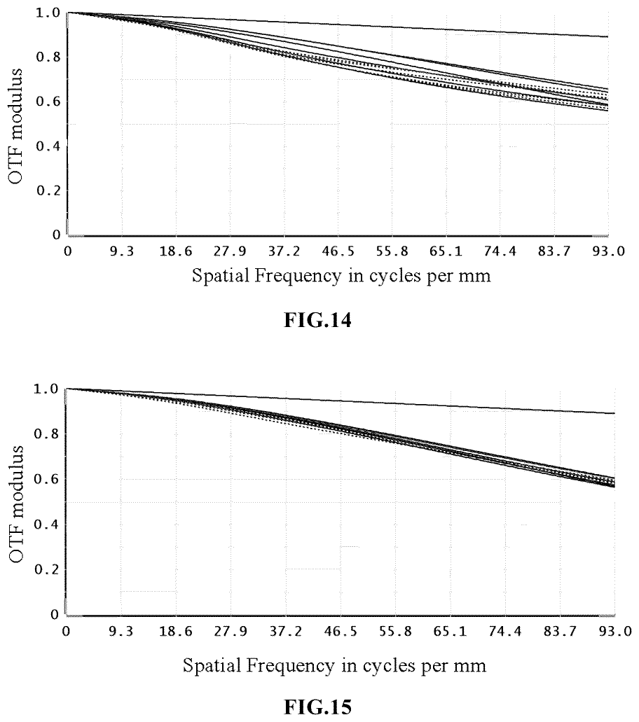

FIG. 14 illustrates a modulation transfer function graph when the zoom projection lens shown in the present embodiment is at the long focal length end. FIG. 15 illustrates a modulation transfer function graph when the zoom projection lens shown in the present embodiment is at the short focal length end.

Referring to FIG. 14, wherein the horizontal axis represents spatial frequency (Spatial Frequency in cycles per mm), and the vertical axis represents the modulus of the OTF. As can be seen from FIG. 14 that in the spatial frequency of 0 to 93 mm, the modulus value of the OTF may always be kept above 0.55. Generally speaking, the closer the modulus value of the OTF is to 1, the higher the quality of the image. However, due to various factors, there is no situation where the modulus value of the OTF is 1. Generally, when the modulus value of the OTF may be kept above 0.55, it indicates that the image has a very high imaging quality, and an excellent clarity. Therefore, it can be concluded that the zoom projection lens in the present embodiment has a higher imaging quality.

Referring to FIG. 15, wherein the horizontal axis represents spatial frequency (Spatial Frequency in cycles per mm), and the vertical axis represents the modulus of the OTF. As can be seen from FIG. 15 that in the spatial frequency of 0 to 93 mm, the modulus value of the OTF may always be kept above 0.57. Generally speaking, the closer the modulus value of the OTF is to 1, the higher the quality of the image. However, due to various factors, there is no situation where the modulus value of the OTF is 1. Generally, when the modulus value of the OTF may be kept above 0.57, it indicates that the image has a very high imaging quality, and an excellent clarity. Therefore, it can be concluded that the zoom projection lens in the present embodiment has a higher imaging quality.

In the present embodiment, the zoom projection lens has a system focal length of 21.3 mm (short focus end)-32.3 mm (long focus end) and a zooming ratio of 1.5×.

The present design may project a clear picture at a distance of 2 meters, and may ensure a clear picture in the range of 1.5 to 4 meters by adjusting the rear focus of the lens.

The field of view of the zoom projection lens: 5°-8.5°; the image circle diameter: 5.5 mm-6.5 mm; the system F-number: 1.65-1.75.

The present system is suitable for 0.23″ DMD TR 4-6 design. That is, the embodiment of the present disclosure constructs an optical architecture suitable for 0.23″ DMD TR 4-6 by using eight lenses, which compared to the prior art, reduces the number of lenses used as well as the volume of the zoom projection lens.

In summary, the distortion produced by the zoom projection lens in its zooming range is controlled (corrected) within a small range. The zoom projection lens exhibits good imaging quality.

### Embodiment Four

Embodiment Four differs from Embodiment One in that there are differences in the curvature radius and thickness dimensions of each lens.

In the present embodiment, the characteristic parameters of each lens and the aperture stop 9 are shown in Table 7 and Table 8. Specifically, Table 7 shows the curvature radius, thickness, refractive index, and Abbe number corresponding to each lens and the aperture stop 9 when the zoom projection lens is at the long focus end. Table 8 shows the curvature radius, thickness, refractive index, and Abbe number corresponding to each lens and the aperture stop 9 when the zoom projection lens is at the short focus end.

Specifically, in Tables 7 and 8, the thickness represents the axial distance from the corresponding surface to the next surface; Nd is the refractive index of the d-light (wavelength of 587 nanometers, same below) for the corresponding lens; Vd is the Abbe number of the d-light for the corresponding lens.

TABLE 7

| | curvature | | refractive | Abbe |
|---|---|---|---|---|
| serial | radius mm | thickness mm | index | number |
| number | (Radius) | (Thickness) | (Nd) | (Vd) |
| 1/2 | 54.7 | 3.72 | 1.6 | 65.5 |
| | −71.7 | 1.04 | | |
| | −280 | 23.48 (variable | 1.76 | 26.6 |
| | | air gap) | | |
| 3 | 11.8 | 7.55 | 1.81 | 25.5 |
| | 6.2 | 5.55 | | |
| 9 | Infinity | 6.3 | / | / |
| 4/5 | −11.4 | 4.4 | 1.73 | 54.7 |
| | −7.8 | 0.96 | | |
| | −10.52 | 3.37 (variable air | 1.81 | 25.5 |
| | | gap) | | |
| 6/7 | 28.64 | 1.01 | 1.9 | 31.3 |
| | 12.72 | 2.86 | | |
| | −70 | 0.1 (variable air | 1.79 | 47.5 |
| | | gap) | | |
| 8 | 25.86 | 1.64 | 1.5 | 81.6 |
| | 144 | 2.3 | | |

TABLE 8

| | curvature | | refractive | Abbe |
|---|---|---|---|---|
| serial | radius mm | thickness mm | index | number |
| number | (Radius) | (Thickness) | (Nd) | (Vd) |
| 1/2 | 54.7 | 3.72 | 1.6 | 65.5 |
| | −71.7 | 1.04 | | |
| | −280 | 0.09 (variable air | 1.76 | 26.6 |
| | | gap) | | |
| 3 | 11.8 | 7.55 | 1.81 | 25.5 |
| | 6.2 | 5.55 | | |
| 9 | Infinity | 6.3 | / | / |
| 4/5 | −11.4 | 4.4 | 1.73 | 54.7 |
| | −7.8 | 0.96 | | |
| | −10.52 | 0.07 (variable air | 1.81 | 25.5 |
| | | gap) | | |
| 6/7 | 28.64 | 1.01 | 1.9 | 31.3 |
| | 12.72 | 2.86 | | |
| | −70 | 3.8 (variable air | 1.79 | 47.5 |
| | | gap) | | |
| 8 | 25.86 | 1.64 | 1.5 | 81.6 |
| | 144 | 2.3 | | |

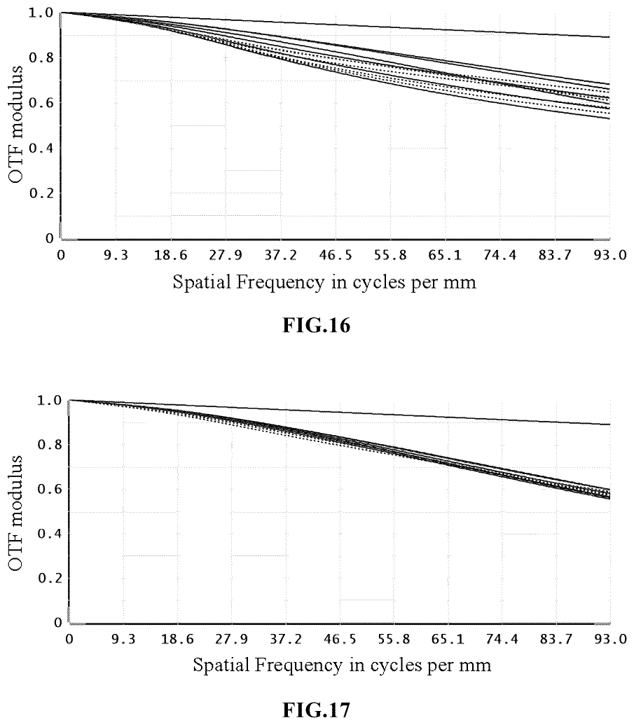

FIG. 16 illustrates a modulation transfer function graph when the zoom projection lens shown in the present embodiment is at the long focal length end. FIG. 17 illustrates a modulation transfer function graph when the zoom projection lens shown in the present embodiment is at the short focal length end.

Referring to FIG. 16, wherein the horizontal axis represents spatial frequency (Spatial Frequency in cycles per mm), and the vertical axis represents the modulus of the OTF. As can be seen from FIG. 16 that in the spatial frequency of 0 to 93 mm, the modulus value of the OTF may always be kept above 0.52. Generally speaking, the closer the modulus value of the OTF is to 1, the higher the quality of the image. However, due to various factors, there is no situation where the modulus value of the OTF is 1. Generally, when the modulus value of the OTF may be kept above 0.52, it indicates that the image has a very high imaging quality, and an excellent clarity. Therefore, it can be concluded that the zoom projection lens in the present embodiment has a higher imaging quality.

Referring to FIG. 17, wherein the horizontal axis represents spatial frequency (Spatial Frequency in cycles per mm), and the vertical axis represents the modulus of the OTF. As can be seen from FIG. 17 that in the spatial frequency of 0 to 93 mm, the modulus value of the OTF may always be kept above 0.57. Generally speaking, the closer the modulus value of the OTF is to 1, the higher the quality of the image. However, due to various factors, there is no situation where the modulus value of the OTF is 1. Generally, when the modulus value of the OTF may be kept above 0.57, it indicates that the image has a very high imaging quality, and an excellent clarity. Therefore, it can be concluded that the zoom projection lens in the present embodiment has a higher imaging quality.

In the present embodiment, the zoom projection lens has a system focal length of 21.3 mm (short focus end)-32.3 mm (long focus end) and a zooming ratio of 1.5×.

The present design may project a clear picture at a distance of 2 meters, and may ensure a clear picture in the range of 1.5 to 4 meters by adjusting the rear focus of the lens.

The field of view of the zoom projection lens: 5°-8.5°; the image circle diameter: 5.5 mm-6.5 mm; the system F-number: 1.65-1.75.

The present system is suitable for 0.23″ DMD TR 4-6 design. That is, the embodiment of the present disclosure constructs an optical architecture suitable for 0.23″ DMD TR 4-6 by using eight lenses, which compared to the prior art, reduces the number of lenses used as well as the volume of the zoom projection lens.

In summary, the distortion produced by the zoom projection lens in its zooming range is controlled (corrected) within a small range. The zoom projection lens exhibits good imaging quality.

The above embodiments focus on the differences between the various embodiments, and the different optimization features between the various embodiments, as long as they do not contradict each other, may be combined to form a better embodiment, which will not be repeated herein taking into account the brevity of the text. Although some specific embodiments of the present disclosure have been described in detail through examples, those skilled in the art should understand that the above examples are for illustration only and are not intended to limit the scope of the present disclosure. Those skilled in the art should understand that the above embodiments can be modified without departing from the scope and spirit of the present disclosure. The scope of the present disclosure is defined by the accompanying claims.

1. A zoom projection lens, comprising: a first zoom lens group, a second zoom lens group, a compensation lens group, and a fixed lens group, positioned sequentially along an optical axis direction from a zoom-in side to a zoom-out side;
wherein, the first zoom lens group has a positive focal power, the second zoom lens group has a negative focal power, the compensation lens group has a positive focal power, and the fixed lens group has a positive focal power; and
the first zoom lens group, the second zoom lens group, and the compensation lens group are movable along the optical axis.

2. The zoom projection lens according to claim 1, wherein lenses of the first zoom lens group, the second zoom lens group, the compensation lens group, and the fixed lens group are all spherical lenses.

3. The zoom projection lens according to claim 1, wherein in a zooming process of the zoom projection lens from a short focus end to a long focus end, a first air gap between the first zoom lens group and the second zoom lens group gradually widens, a second air gap between the second zoom lens group and the compensation lens group gradually widens, and a third air gap between the compensation lens group and the fixed lens group gradually narrows.

4. The zoom projection lens according to claim 3, wherein at the long focus end of the zoom projection lens, the zoom projection lens has a total optical length of TTL1, the first air gap is has a width of d1, and the second air gap has a width of d2, satisfying: 0.25≤d1/TTL1 ≤0.3; 0.03≤d2/TTL1≤0.07.

5. The zoom projection lens according to claim 3, wherein at the short focus end of the zoom projection lens, the zoom projection lens has a total optical length of TTL2 and the third air gap is has a width of d3, satisfying the following formula: 0.04≤d3/TTL2≤0.06.

6. The zoom projection lens according to claim 1, wherein the zoom projection lens has a working F-number, which satisfies: 1.6≤working F-number≤1.8.

7. The zoom projection lens according to claim 1, wherein the first zoom lens group comprises a first lens with a positive focal power and a second lens with a negative focal power.

8. The zoom projection lens according to claim 1, wherein the second zoom lens group comprises a third lens, a fourth lens, and a fifth lens, the third lens has a negative focal power, and the fourth lens and the fifth lens haves opposite focal powers to each other.

9. The zoom projection lens according to claim 8, wherein the zoom projection lens comprises an aperture stop, located between the third lens and the fourth lens.

10. The zoom projection lens according to claim 8, wherein the fourth lens and the fifth lens are cemented together to form a doublet lens.

11. The zoom projection lens according to claim 1, wherein the compensation lens group comprises a sixth lens and a seventh lens, which have opposite focal powers.

12. The zoom projection lens according to claim 1, wherein the fixed lens group comprises an eighth lens with a positive focal power.

13. The zoom projection lens according to claim 1, wherein each of the first zoom lens group, the second zoom lens group, and the compensation lens group comprises a cemented lens.

14. The zoom projection lens according to claim 1, wherein effective focal lengths of the first zoom lens group, the second zoom lens group, the compensation lens group, and the fixed lens group are f1, f2, f3, and f4 respectively, the zoom projection lens has a short focus end focal length of fw, which satisfies: 3.52≤f1/fw≤3.80, 1.41≤f2/fw≤1.17, 1.41≤f3/fw≤1.64, and 2.96≤f4/fw≤3.19.

15. An electronic device, comprising a zoom projection lens according to claim 1.
